(19) United States
(12) Patent Application Publication
(10) Pub. No.: US 2015/0017354 A1
(43) Pub. Date: Jan. 15, 2015

(54) Solar Glass Pane

(71) Applicant: Sean James O'Flaherty, Sparks, NV (US)

(72) Inventor: Sean James O'Flaherty, Sparks, NV (US)

(21) Appl. No.: 13/939,452

(22) Filed: Jul. 11, 2013

(51) Int. Cl. B32B 17/06

(52) U.S. Cl. CPC B32B 17/06
USPC 428/34

(57) ABSTRACT

Specification solar glass pane has been designed as a Green Energy Source.

### SUMMARY

The solar glass pane would be constructed as follows: One concealed transparent glass pane (piece) with an exterior face plate. An interior face plate and a hollow core, encased in glass, tempered within accordance.

The exterior face plate would be forged to induce (magnify) heat. The interior face plate would be forged to reflect induced (magnified) heat. The core would be hollow and air tight all around allowing no moisture or air. The glass incased rim (frame) would be forged with a sealed heat extraction lead.

How it works: The ultraviolet rays from the sun radiate the exterior face plate, magnifying inducing radiation. The interior face plate would then reverse the radiation converging back to the core, creating a controlled flow of induced heat current build up centered set forth at the core. That heat current would need to exhaust its extreme consistent engaging heat build up, needing to protrude through the rim (frame). The heat extraction lead would then be tapped and pulled to an electrical generator.

### SOLAR GLASS PANE ABSTRACT OF THE DISCLOSURE

The solar glass pane would be constructed, manufactured and concealed as follows: There will be two glass tempered panes each manufactured individually. The exterior face pane would be forged to induce radiation to its center. The interior face pane would be forged to reflect all induced radiation back to its center. In order to engage the two glass temperature panes, there will be a forged solid tapable heat extraction ring plate (conductor). That ring plate will be the exact circumference of the shaped panes (square, round, octagon, etc. etc.). Specifications of the panes tempered thickness and the ring width, thickness and plate makeup will be determined as thin as possible by the engineers. The ring plate would then be centered, pressed and vacuum sealed between the two solar glass panes, creating a thin hollow air tight core between the panes equaling one pane (piece). Once radiated this will create a positive controlled induced heat wave set forth between the two panes that would then direct all the energy to the ring plate. In order to achieve a non restrictive concurring stream of radiation, the ring plate would be made with composites that will not transmit heat or radiation back to the glass if it is set flush. The ring plate's job is to engulf and flow the radiation without resistance.

This will allow the exterior face pane to remain stable at atmospheric temperatures. In addition, the interior face pane will remain stable at room temperatures. Once the ring plate is tapped by a compatible conduit the radiated heat current will be stream lined to an electrical storage unit.

Note: Drawings are not necessary for the understanding of the subject sought

NOTE: Once constructed the glass pane would resemble a typical window we are accustomed to seeing through.

The purpose of the solar glass invention: To install solar glass panes into buildings such as skyscrapers and homes. The panes would act as a green electric energy source for a building and as a window pane.

1. Solar glass pane.
